(19) United States
(12) Patent Application Publication
(10) Pub. No.: US 2026/0169341 A1
(43) Pub. Date: Jun. 18, 2026

(54) ELECTRONIC DEVICES WITH A FRONT LIGHT PANEL LAYER

(71) Applicant: Amazon Technologies, Inc., Seattle, WA (US)

(72) Inventors: Bin Hou, San Jose, CA (US); Weihsin Hou, Fremont, CA (US)

(21) Appl. No.: 18/979,040

(22) Filed: Dec. 12, 2024

(51) Int. Cl. G02F 1/16766; G02F 1/167; G02F 1/1677; G06F 3/046

(52) U.S. Cl. CPC G02F 1/16766; G02F 1/167; G02F 1/1677; G06F 3/046

(57) ABSTRACT

Systems are described for illuminating screens of electronic devices. An example display device comprises a micro LED light panel layer comprising a plurality of micro LEDs configured to direct visible light toward a reflective display layer. The example comprises a touch layer comprising a touch sensor and a substrate. The example comprises a reflective display layer comprising a color filter array comprising a plurality of color filters and an electrophoretic display comprising a plurality of pixels. The example comprises an electromagnetic resonance layer comprising a wire grid configured to generate an electromagnetic field to power a stylus device. The example comprises a pressure-sensitive adhesive layer configured to couple the reflective display layer to the electromagnetic resonance layer. The example comprises a cover lens layer comprising a glass or a plastic and is configured to shield the display device from external hazards.

### BACKGROUND

Electronic readers (e-readers) are portable electronic devices for reading digital copies of books. Some e-readers use e-ink displays to mimic the appearance of printed words on paper. E-ink displays create black and white pixels by applying an electric field to positively charged white particles and negatively charged black particles suspended in a clear fluid. The black and white particles move in response to the electric field to create black or white pixels on the screen. Some e-readers contain Light Emitting Diodes (LEDs) around the edges of the screen to provide illumination.

### BRIEF DESCRIPTION OF DRAWINGS

FIG. 1A illustrates an example electronic device with an example light panel layer, in accordance with various aspects of the present disclosure.

FIG. 1B illustrates an example electronic device with an example light panel layer, in accordance with various aspects of the present disclosure.

FIG. 2 illustrates a block diagram of an example display stack for a display device, in accordance with various aspects of the present disclosure.

FIG. 3 illustrates a block diagram of an example display stack for a display device, in accordance with various aspects of the present disclosure.

FIG. 4 illustrates a block diagram of an example display stack for a display device, in accordance with various aspects of the present disclosure.

FIG. 5 illustrates a block diagram of an example display stack for a display device, in accordance with various aspects of the present disclosure.

FIG. 6A illustrates an example lighting system, in accordance with various aspects of the present disclosure.

FIG. 6B illustrates an example lighting system, in accordance with various aspects of the present disclosure.

FIG. 7 illustrates a block diagram of an example lighting system, in accordance with various aspects of the present disclosure.

FIG. 8 illustrates a block diagram for an example electronic device, in accordance with various aspects of the present disclosure.

FIG. 9 illustrates a block diagram for a traditional display device, in accordance with various aspects of the present disclosure.

### DETAILED DESCRIPTION

In the following description, reference is made to the accompanying drawings which illustrate several examples for the present disclosure. It is understood that other embodiments may be utilized, and that mechanical, compositional, structural, electrical operational changes may be made without departing from the spirit and scope of the present disclosure. The following detailed description is not to be taken in a limiting sense, and the scope of the embodiments of the present invention is defined only by the claims of the issued patent.

Many users prefer electronic reader (e-reader) devices (and other types of display devices) because they can offer a variety of advantages over printed forms of media, such as paperback books, textbooks, magazines, pamphlets, and/or the like. For example, an e-reader can easily store the equivalent of dozens of books (or more) in a single lightweight and portable device that a user can easily carry in a purse or backpack (e.g., when commuting to work, class, etc.). In such examples, the size and/or weight of even a few printed books may make travel (e.g., commuting, vacationing, etc.) with them prohibitive for some users. Additionally, or alternatively, e-readers (or the like) can also allow users to adjust font sizes, contrast, and/or illumination, making for an easier reading experience which may be less strenuous on a user's eyes. Additionally, or alternatively, many e-readers (or the like) may include interactive screens that can allow a user to take notes and/or highlight text (e.g., by using a touchscreen and/or stylus pen). These notes and/or highlights can also be easily cleared which may not be possible when taking notes in a physical book (or the like).

Moreover, display devices (e.g., e-readers, etc.) may connect to the Internet and offer users the ability to purchase and/or download books from most places in real-time (or near-real-time) which can provide users with a seamless and enjoyable way to access written media from nearly anywhere at almost any time. Many users and/or publishers may also prefer e-readers (or the like) over printed materials because e-readers can reduce the costs associated with manufacturing and distributing (and/or purchasing) printed materials. Additionally, or alternatively, electronic display devices can reduce the impact that printing physical books (or the like) may have on the environment. For example, e-readers may reduce (or eliminate), at least in part, the number (and/or amount) of raw materials (e.g., paper, ink, electricity to run printing presses, fuels to distribute physical copies by vehicle, etc.) required for publishing physical books (or the like). A single e-reader, for instance, may be able to replace hundreds of books and/or other printed media material for a user over the life of the electronic device. In addition, at the end of its working life it may be much easier and environmentally friendly to recycle or refurbish a single electronic device (e.g., rather than hundreds or thousands of printed books).

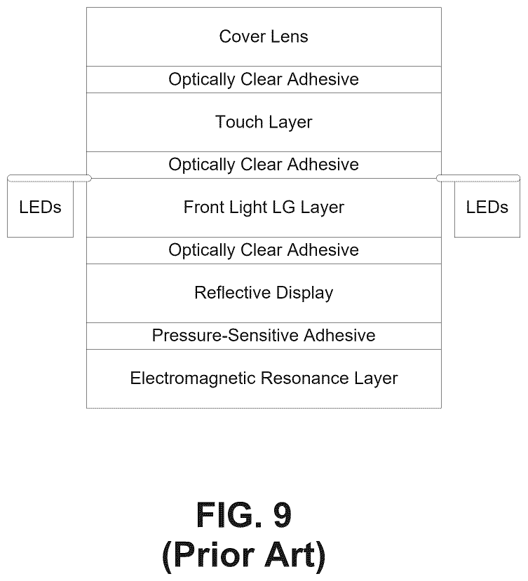

Traditional display devices (e.g., e-reader devices) utilize a traditional display device including a traditional display stack. Traditional display devices include an edge lit front light system (e.g., traditional LEDs adjacent a Light Guide (LG) layer) that is illuminated by LEDs which are located around the edge of the front light LG layer (as shown in FIG. 9 which illustrates a block diagram for a traditional display device). In addition, the LEDs need to be disposed in the bezel of the display device which necessitates a wider (or thicker) bezel to house the LEDs required to illuminate the edge lit front light LG layer. Additionally, or alternatively, traditional display devices that utilize an edge lit front light LG layer traditionally lack the ability to render images and/or adjust the lighting for specific portions (or sections) of a screen of the display device. For example, because the front light LG layer diffuses light from the edge mounted LEDs, particular portions (or sections) of the screen cannot be isolated for respective illumination, brightness, highlighting, and/or coloring using the edge mounted LEDs. For instance, if only the bottom half of the edge mounted LEDs were illuminated then the front light LG layer would still diffuse (or carry), at least in part, the light from the bottom half of the screen to the top half of the screen (e.g., producing a gradient of light through the entire LG layer). Additionally, or alternatively, if some of the LEDs were configured to produce a yellow colored light (e.g., to highlight a particular portion of the screen) and the remaining LEDs produced a white colored light, then the different colors would blend (or bleed) together in the front light LG layer. It should be understood that this phenomena would weaken or completely negate any visual highlighting effect produced by the yellow LEDs. For similar reasoning the front light LG layer is unable to render images and/or color images that are rendered by any other layer(s) (e.g., a reflective display layer, etc.) of a traditional display device. Some traditional display devices, display devices, and/or display stacks do not include an edge lit front light LG layer (or any similar lighting layer(s)) and, thus, require a user to rely on ambient light from an external environment (e.g., the sun, a lamp, a flashlight, etc.) similar to traditional printed books (or the like).

In contrast to the traditional display devices (e.g., e-reader devices, etc.) described above, improved e-reader devices and/or other display devices utilizing micro LED light panels are described herein. In addition, improved lighting systems (and/or lighting devices) for use with e-reader devices and/or display devices are also described herein. The present disclosure sets forth systems, devices, and apparatuses that, among other things, provide improvements to display device technologies (e.g., e-reader device technologies, etc.). There are many advantages of these, and other examples described herein over traditional systems, such as those traditional systems described above.

One advantage of one or more systems and/or devices described herein is that such systems and/or devices can be manufactured with thinner (or narrower) bezels than traditional display devices (e.g., e-reader devices, etc.) described above. For example, as described herein improved display devices (e.g., e-reader devices, etc.) utilize a micro LED light panel layer (e.g., with microscopic LEDs configured or disposed throughout the light panel) and, thus, do not depend (or rely) on edge-mounted LEDs (e.g., configured or disposed in a bezel or frame around a screen) to illuminate an edge lit front light system (e.g., LG layer, etc.). Accordingly, such edge-mounted LEDs may be optionally omitted and the bezel (or frame) around a screen of improved display devices (as described herein) can be made thinner (or narrower) as the space required to house the edge mounted LEDs (or other lighting strips, such as fiber optics or the like) is not necessary.

Another advantage of one or more systems and/or devices described herein is that such systems and/or devices can control, at least in part, a micro LED light panel layer to render one or more of an image, a symbol, and/or the like as described herein on one or more portions (or sections) of a screen of an improved display device. Additionally, or alternatively, one or more systems and/or devices described herein may control, at least in part, a micro LED light panel layer to adjust one or more display (or lighting) parameters for specific portions (or sections) of a screen of an improved display device. For example, one or more subsets of micro LEDs making up the micro LED light panel layer may be isolated (e.g., controlled separately from each other) to provide respective illumination, brightness, highlighting, coloring, and/or the like for respective portions (or sections) of a screen of an improved display device (as described herein).

Another advantage of one or more systems and/or devices described herein is that such systems and/or devices can be manufactured with thinner display devices (and/or display stacks) than traditional display devices (e.g., e-reader devices, etc.) described above. For example, as described herein improved display devices (e.g., e-reader devices, etc.) may integrate a micro LED light panel layer into a cover lens layer and, thus, can reduce the total number of layers (and/or overall thickness) of a screen (e.g., of a display device). Accordingly, in some examples, improved display devices (as described herein) can be made thinner because the depth (or thickness) required for both a distinct cover lens layer and a distinct light panel layer can be, at least in part, consolidated into a single layer (e.g., a hybrid layer, a cover lens with a built in light panel, or a protective light panel layer that also functions as a cover lens). Additionally, or alternatively, the cover lens layer and the light panel layer may be fused together (e.g., during manufacture) to remove the need for an intervening adhesive layer (e.g., optically clear adhesive, etc.) to mechanically couple a distinct cover lens layer to a distinct light panel layer.

Moreover, it should be appreciated that such examples as set forth herein solve particular technical problems, such as those identified and described above for traditional camera calibration and/or localization systems and techniques. It will be appreciated that the scope of the present disclosure encompasses many potential example embodiments in addition to those described above, some of which will be described in further detail below.

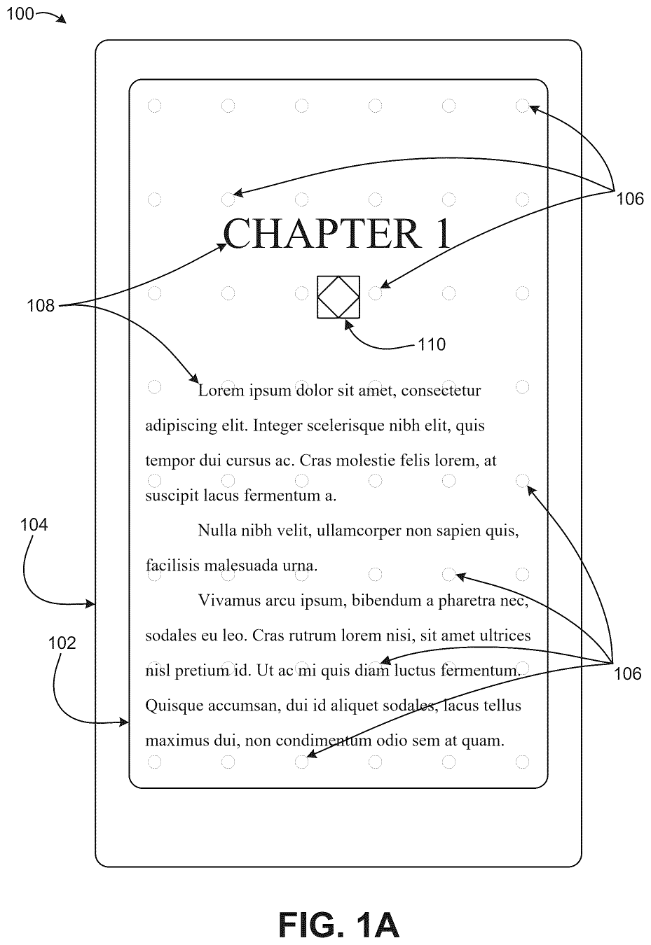

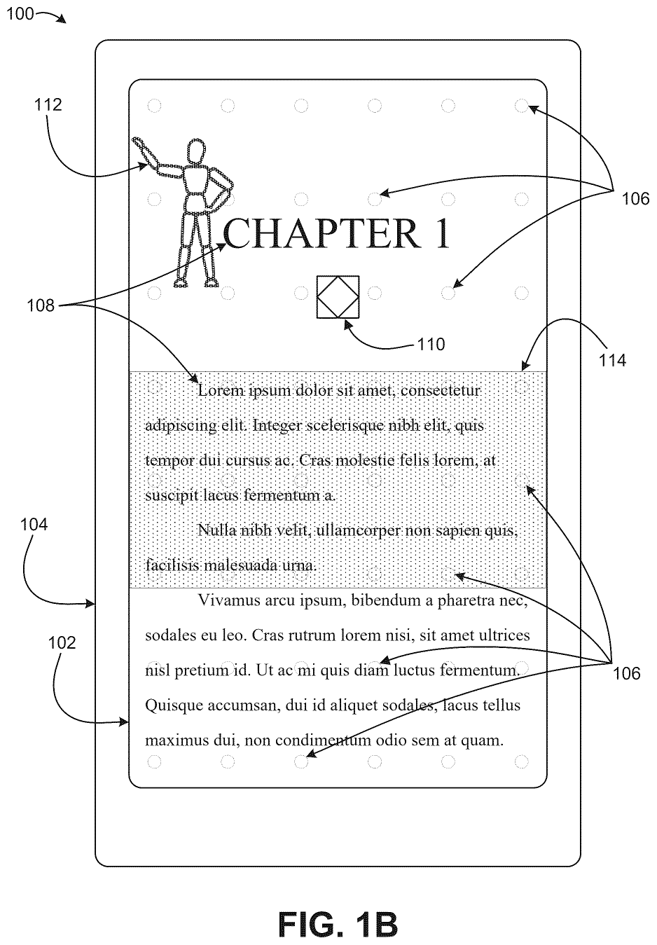

Now that some advantages associated with various example systems and/or devices described herein have been described above in contrast with traditional systems and devices, an example electronic device with an example light panel layer will now be described below with reference to FIGS. 1A and 1B.

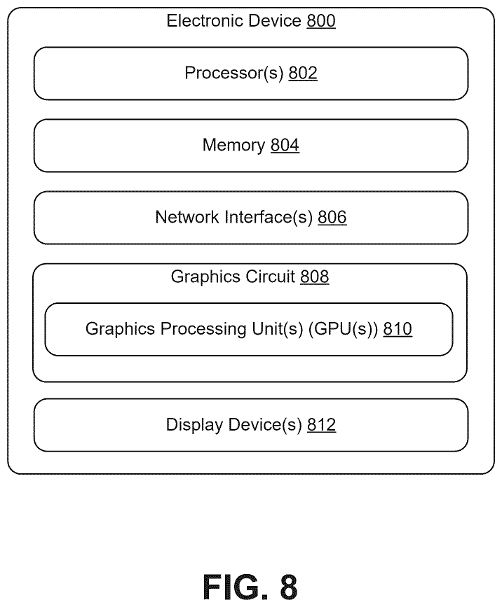

FIG. 1A illustrates an example electronic device with an example light panel layer, in accordance with various aspects of the present disclosure. As shown, the electronic device 100 may comprise a display device 102, a housing 104, a plurality of micro LEDs 106, text 108, and/or symbols 110. The electronic device 100 may comprise one or more of a display device (e.g., an e-reader, monitor, etc.) a tablet, a smartphone, a laptop computer, and/or any other electronic device (e.g., electronic device 800 as described below in connection with FIG. 8) configured to render, at least in part, text, symbols, images, and/or the like, such as shown in FIGS. 1A and/or 1B.

For example, the electronic device 100 may be any electronic device (described herein) configured to execute (e.g., using processor(s) 802, etc.) computer executable program code (e.g., applications, software, etc.) that is configured to download and/or render one or more forms of digital media (e.g., electronic books, magazines, newspapers, etc.). Additionally, or alternatively, the electronic device 100 may be any electronic device (described herein) configured to store (e.g., using memory 804, etc.) one or more forms of digital media. In some examples, the electronic device 100 may be communicatively coupled (e.g., using network interface(s) 806, etc.) to one or more other electronic devices (e.g., computers, servers, etc.) through one or more communications networks (e.g., the Internet, a mobile network, etc.) in order to exchange data (e.g., download digital media, process payments, etc.).

The display device 102, as shown, may be any display device and/or display circuitry comprising a display stack as described herein for rendering text (e.g., text 108) and/or symbols (e.g., symbols 110). As shown, the display device 102 may comprise a plurality of micro LEDs 106. The plurality of micro LEDs 106, as shown, may be embedded (or disposed), at least in part, in one or more micro LED light panel layers as described herein. In some examples, the display device 102 may comprise one or more of a screen, a monitor, a touchscreen, a display stack, and/or the like as described herein. In some examples, the plurality of micro LEDs 106 may comprise one or more of a Red Green Blue (RGB) micro LED, a color conversion micro LED, a flexible micro LED, a transparent micro LED, and/or any other micro LED as described herein. As shown, the plurality of micro LEDs 106 are illustrated in a grid pattern and are depicted as being equidistant relative to a lateral axis and/or a longitudinal axis relative to the display device 102 (e.g., aligned in columns and rows that are parallel to the edges of the housing 104, etc.).

It should be understood that the plurality of micro LEDs 106 are shown in the depicted configuration for illustrative purposes and to facilitate clearer description of the examples described herein. Accordingly, the plurality of micro LEDs 106 should not be interpreted as representing only the depicted configuration (e.g., layout, number, size, shape, etc.) unless specifically stated otherwise for a given example and/or otherwise understood within the context of a given example. In some examples, the plurality of micro LEDs 106 may be configured (or disposed), at least in part, in a staggered pattern, an offset pattern, a curved (or circular) pattern, and/or any other pattern described herein. In some examples, the spacing (or distance) between each pair of micro LEDs along a lateral and/or longitudinal axis (e.g., relative to the display device 102) may be greater than (or less than) the spacing (or distances) illustrated in FIGS. 1A and 1B. In some examples, two or more micro LEDs of the plurality of micro LEDs 106 may, at least in part, be configured to touch (or abut). For example, an edge of a first micro LED may be placed against an edge of at least a second micro LED. In some such examples, each micro LED of the plurality of micro LEDs 106 may touch each neighboring micro LED in a lateral direction, a longitudinal direction, and/or a diagonal direction (e.g., relative to the display device 102). For instance, the plurality of micro LEDs 106 may be configured to function (or act) as pixels (e.g., render images, etc.). Accordingly, for example, if a display device has a resolution equivalent to 1448×1072 pixels (or any other resolution) then the plurality of micro LEDs 106 may comprise 1448×1072 microscopic LEDs (or any other resolution).

The text 108, as shown, may be any text from any written digital media (e.g., electronic books, magazines, newspapers, etc.) as described herein. In some examples, the font characteristics of the text 108 including the font style, font size, font color, and/or any other font characteristics described herein may be adjustable (or controllable) by the display device 102. For example, a user may define (or redefine) one or more particular font characteristics for the text 108, such as by providing one or more user inputs to the touch layer (e.g., of the display device 102). In some examples, the electronic device 100 may generate (or render) the text 108 (e.g., black and white text) using, at least in part, a reflective display layer (e.g., reflective display layer 210, etc.) of the display device 102. The symbols 110, as shown, may be any geometric symbol from any written digital media as described herein. For example, as shown, the symbols 110 comprise a diamond (or a rotated square) within another square. In some examples, the symbols 110 may comprise any shape such as a circle, a square, rectangle, triangle, and/or the like as described herein which may be rendered by the display device 102. In some examples, the electronic device 100 may generate (or render) the symbols 110 (e.g., black and white symbols) using, at least in part, a reflective display layer of the display device 102.

The housing 104, as shown, may be any electronic device enclosure for housing, at least in part, any electronic components of the electronic device 100 (e.g., processors, circuit boards, the display device 102, etc.). In some examples, the housing 104 may comprise one or more of a plastic, a glass, a metal (e.g., steel, aluminum, etc.), and/or any other materials described herein. In some examples, the housing 104 may comprise (or define) a boundary between the electronic device 100 and an external environment. In some examples, the housing 104 may comprise, at least in part, a top layer (e.g., cover lens layer, a topmost layer, uppermost layer, etc.) of the display device 102 (or any other display device described herein).

FIG. 1B illustrates an example electronic device with an example light panel layer, in accordance with various aspects of the present disclosure. As shown in FIG. 1B, the electronic device 100 may further comprise one or more of an image 112, a highlight 114, and/or the like as described herein.

The image 112, as shown, may be one or more of any geometric symbol (e.g., a straight line, triangle, etc.), organic shape (e.g., a hand drawn line, a freeform oval, a blob shape, etc.), picture (e.g., photograph, etc.), image (e.g., representing a person, a place, an object, etc.), and/or the like as described herein. For example, as shown, the image 112 may comprise a humanoid figure (e.g., cartoon character, person, etc.) in one or more poses. In some examples, the image 112 may comprise one or more of a black and white image (or picture) and/or a color image (or picture). In some examples, the image 112 may be, at least in part, transparent. For example, if the image 112 is rendered above the text 108 and/or the symbols 110, then the text 108 and/or the symbols 110 may be, at least in part, visible behind (or below) the image 112. In some examples, the image 112 may be, at least in part, opaque. For example, if the image 112 is rendered above the text 108 and/or the symbols 110, then the text 108 and/or the symbols 110 may be, at least in part, covered, blocked, or obscured by the image 112.

As shown, in some examples, the electronic device 100 may generate (or render) the image 112 (e.g., one or more images as described herein) using, at least in part, the plurality of micro LEDs 106 of the display device 102. It will be understood that one or more micro LED light panel layers (as described herein) may comprise the plurality of micro LEDs 106 and/or any other circuitry (e.g., electrical connections, etc.) for rendering one or more images (e.g., image 112). In some examples, a piece of digital media (e.g., electronic books, magazines, newspapers, etc.) may comprise computer executable program code (e.g., instructions, etc.) to cause an electronic device to render the image 112 (or the like) in response to a determination that the display device (of the electronic device) comprises at least one micro LED light panel layer.

The highlight 114, as shown, may be one or more of a color, shape, underline, and/or the like for visually emphasizing a portion (or section) of a display device from another portion (or section) of the same display device as described herein. For example, as shown, the highlight 114 may comprise one or more of a color, a pattern, and/or a brightness that is different (or distinct) from other areas of a screen of the electronic device 100. In some examples, the highlight 114 may be, at least in part, transparent. For example, the highlight 114 may comprise one or more transparent yellow (or any other color) boxes (or rectangles) rendered above a subset (or portion) of the text 108 that visually emphasizes the highlighted subset (or portion) of text over the unhighlighted subsets (or portions) of the text 108. In some examples, the highlight 114 may be, at least in part, opaque. For example, the highlight 114 may comprise one or more opaque yellow (or any other color) borders (and/or underlines) to further emphasize the highlighted subset (or portion) of text over the unhighlighted subsets (or portions) of the text 108. In some examples, the highlight 114 may be one or more of a circle, box, rectangle, and/or any other shape that, at least in part, encircles (or defines) a highlighted area of the screen of the display device 102. In some examples, the highlight 114 may emphasize (or highlight) a subset (or portion) of the screen of the display device 102 (e.g., that comprises a symbol (e.g., symbols 110, etc.) and/or an image (e.g., image 112, etc.)).

As shown, in some examples, the electronic device 100 may generate (or render) the highlight 114 using, at least in part, the plurality of micro LEDs 106 of the display device 102. It will be understood that one or more micro LED light panel layers (as described herein) may comprise the plurality of micro LEDs 106 and/or any other circuitry (e.g., electrical connections, etc.) for rendering one or more highlights (e.g., highlight 114). In some examples, a piece of digital media (e.g., electronic books, magazines, newspapers, etc.) may comprise computer executable program code (e.g., instructions, etc.) to cause an electronic device to render the highlight 114 (or the like) in response to a determination that the display device 102 comprises at least one micro LED light panel layer. In some examples, the electronic device 100 may render a highlight (e.g., highlight 114, etc.) over any portion of a screen of the display device 102, such as in response to a user input to a touch layer (e.g., with a finger, etc.) and/or an electromagnetic resonance layer (e.g., with a stylus, etc.). In some examples, a user input may indicate one or more highlight characteristics for highlighting an area of a screen. Example highlight characteristics may include, without limitation, one or more of a color (e.g., red, yellow, blue, green, purple, etc.), a brightness, a transparency (or opaqueness) level (e.g., 50% transparency or any other number), a shape (e.g., underline, square, rectangle, circle, etc.), and/or any other characteristics of a highlight as described herein. In some examples, an electromagnetic resonance layer may be configured to generate an electromagnetic field for inductive interaction with a stylus device.

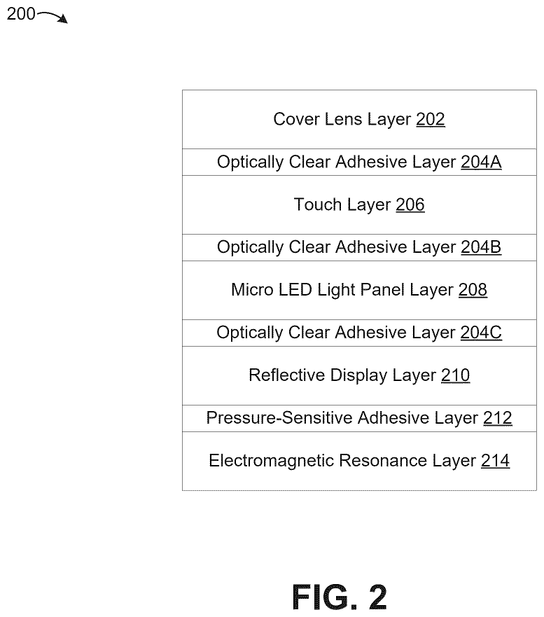

Now that an example electronic device with an example light panel layer has been described above with reference to at least FIGS. 1A and 1B, an example display stack for a display device will now be described below with reference to FIG. 2.

FIG. 2 illustrates a block diagram of an example display stack for a display device, in accordance with various aspects of the present disclosure. As shown, the display stack 200 may comprise a cover lens layer 202, a plurality of Optically Clear Adhesive (OCA) layers, a touch layer 206, a micro LED light panel layer 208, a reflective display layer 210, a Pressure-Sensitive Adhesive (PSA) layer 212, and/or an Electromagnetic Resonance (EMR) layer 214. In some examples, the display device 102 (described above in connection with FIGS. 1A and 1B) may comprise, at least in part, the display stack 200. In some examples, the display stack 200 may comprise, at least in part, any other display stack(s) as described herein. It should be understood that an advantage of the display stack 200 (as depicted in FIG. 2) over traditional display stack configurations (e.g., as shown in FIG. 9) is that the display stack 200 may allow for (or facilitate) a thinner bezel (or frame) configuration (e.g., around the screen) by utilizing micro LEDs throughout the micro LED light panel layer 208 (e.g., in contrast to edge mounted LEDs as shown in FIG. 9).

The cover lens layer 202, as shown, may be any transparent (or semi-transparent) protective layer as described herein for shielding one or more underlying layers of a display stack from an external environment. The cover lens layer 202 may comprise one or more of a scratch resistant material, an impact resistant material, an anti-glare coating, a plastic (e.g., polymer, resin, etc.), a glass, a mineral (e.g., sapphire, silica, etc.), and/or any other cover lens material described herein. In some examples, the cover lens layer 202 may comprise, at least in part, a portion of the housing 104 as described above in connection with FIGS. 1A and 1B. In some examples, the cover lens layer 202 may comprise, at least in part, any other cover lens layer(s) as described herein.

As shown, the cover lens layer 202 may be configured to shield (or protect) underlying layers of the display stack 200 from environmental hazards (e.g., sharp furniture corners, rocks, abrasive surfaces, asphalt, concrete, water, moisture, dust, debris, etc.) while maintaining a clear and readable screen surface (e.g., without cracks, scratches, or warping that may cause image and/or text distortion). For example, the cover lens layer 202 may comprise a scratch resistant sapphire lens with anti-glare coating on the underside (e.g., facing toward the OCA layer 204A) that can resist chipping, cracking, and/or scratching when contacted by a hard and/or abrasive surface (e.g., dropped on, and/or slid along, a concrete surface).

As shown, the cover lens layer 202 may be configured, positioned, or disposed as the topmost layer of the display stack 200 with one or more of the plurality of OCA layers, the touch layer 206, the micro LED light panel layer 208, the reflective display layer 210, the PSA layer 212, and/or the EMR layer 214 configured (or disposed) underneath (or below) the cover lens layer 202. In the depicted example, the cover lens layer 202 may be mechanically coupled to the touch layer 206 by the OCA layer 204A. It should be understood that, in the depicted example of FIG. 2, any area above the cover lens layer 202 may comprise (or define) an exterior environment (relative to a housing of an electronic device) and/or any area below the cover lens layer 202 may comprise (or define) an interior of a housing (e.g., housing 104) of an electronic device (e.g., electronic device 100).

The plurality of OCA layers, as shown, may be one or more of any transparent (or semi-transparent) adhesive layer(s) as described herein for mechanically (and/or chemically) coupling two or more adjacent layers. As depicted in FIG. 2, the plurality of OCA layers may comprise the OCA layer 204A, the OCA layer 204B, and the OCA layer 204C. In some examples, an Optically Clear Adhesive (OCA) may comprise one or more of an acrylic adhesive, a silicone adhesive, a polyurethane adhesive, an epoxy adhesive, and/or any other adhesive described herein. In some examples, an OCA layer may have the same (or similar) refractive index (or refraction index) as one or more adjacent layers in a display stack (e.g., less than a 1% difference, or another number, between refractive indexes). For example, the OCA layer 204A may have a refractive index that is equal to (or within a ±1% tolerance of) the refractive index of the cover lens layer 202 to reduce (or eliminate) the distortion of light as the light passes between the OCA layer 204A and cover lens layer 202 (and/or vice versa). In some examples, one or more of the OCA layers (e.g., OCA layer 204A, etc.) of the plurality of OCA layers of the display stack 200 may comprise, at least in part, any other OCA layer(s) as described herein.

As shown, a respective OCA layer (e.g., OCA layer 204A, etc.) of the plurality of OCA layers may be configured to mechanically (and/or chemically) couple two or more adjacent layers while maintaining a clear and readable screen (e.g., without bubbling, or warping that may cause image and/or text distortion) of a display device. For example, as shown, the OCA layer 204A may comprise a silicone adhesive (or the like) that mechanically (and/or chemically) couples the cover lens layer 202 to the touch layer 206. In addition, as shown, the OCA layer 204B may comprise an epoxy adhesive (or the like) that mechanically (and/or chemically) couples the touch layer 206 to the micro LED light panel layer 208. Further, as shown, the OCA layer 204C may comprise a polyurethane adhesive (or the like) that mechanically (and/or chemically) couples the micro LED light panel layer 208 to the reflective display layer 210.

As shown, a respective OCA layer (e.g., OCA layer 204A, etc.) of the plurality of OCA layers may be configured, positioned, or disposed, as shown in FIG. 2, between at least two adjacent layers. In some examples, two or more of the OCA layer 204A, the OCA layer 204B, and/or the OCA layer 204C may comprise the same type of adhesive. In other examples, each of the OCA layer 204A, the OCA layer 204B, and/or the OCA layer 204C may comprise different types of adhesives (e.g., best suited for coupling their respective adjacent layers).

The touch layer 206, as shown, may be any transparent (or semi-transparent) conductive layer as described herein for detecting one or more user inputs (e.g., a touch or press by a finger, etc.). The touch layer 206 may comprise one or more of a capacitive touch sensor, a resistive touch sensor, a transparent conductive oxide (e.g., indium tin oxide, etc.), a glass (or mineral) substrate, a plastic substrate (e.g., Polyethylene Terephthalate (PET), etc.), nano wires (e.g., silver nanowires, a wire grid, etc.), an anti-glare coating, and/or any other touch layer materials described herein. In some examples, the touch layer 206 may comprise, at least in part, any other touch layer(s) as described herein.

As shown, the touch layer 206 may be configured to detect a user input, such as a user's finger touching (and/or hovering over) a topmost layer of a display stack (e.g., the cover lens layer 202 of the display stack 200 and/or any other topmost layer as described and/or depicted herein). For example, the touch layer 206 may comprise a transparent conductive layer (e.g., indium tin oxide, etc.) configured to generate an electrostatic field. In addition, the touch layer 206 may comprise a capacitive touch sensor that may be configured to detect changes in (or disruption to) the electrostatic field produced when a finger (or other conductive object, such as a stylus) enters the electrostatic field (e.g., at a particular location relative to a screen of a display device). In some examples, the touch layer 206 may comprise a pressure sensitive layer (e.g., a resistive layer and a conductive layer separated by a small gap, etc.) configured to generate a voltage change when pressed (e.g., by a finger, stylus, etc.). In addition, the touch layer 206 may comprise a resistive touch sensor that may be configured to detect changes in voltage produced when a finger (or other object, such as a stylus) exerts a compressive force on the touch layer 206 (e.g., at a particular location relative to a screen of a display device). In some examples, a processor of an electronic device (e.g., electronic device 100, etc.) may receive a signal from the touch layer 206 to determine a position on a screen where a user input was received (e.g., to highlight an area of the screen, turn a page, scroll through text, click on an image or icon, etc.).

As shown, the touch layer 206 may be configured, positioned, or disposed between the cover lens layer 202 and the micro LED light panel layer 208. In the depicted example, the touch layer 206 may be mechanically coupled below the cover lens layer 202 by the OCA layer 204A. In addition, in the depicted example, the touch layer 206 may be mechanically coupled above the micro LED light panel layer 208 by the OCA layer 204B.

The micro LED light panel layer 208, as shown, may be any transparent (or semi-transparent) array of microscopic LEDs as described herein for rendering one or more of an image (e.g., image 112), a highlight (e.g., highlight 114), and/or the like as described herein. The micro LED light panel layer 208 may comprise one or more of a microscopic LED (e.g., any or all of the plurality of micro LEDs 106 or the like), a transparent substrate (e.g., glass, mineral, plastic, polymer, indium tin oxide, etc.), an transparent encapsulating material (e.g., potting material, plastic, polymer, silicone epoxy resin, polyurethane, etc.), an anti-glare coating, a wire (or electrical conduit), a Printed Circuitry Board (PCB) (e.g., thin and/or micro PCB, etc.), and/or any other micro LED light panel materials described herein. In some examples, the micro LED light panel layer 208 may comprise, at least in part, any other micro LED light panel layer(s) as described herein.

As shown, the micro LED light panel layer 208 may be configured to generate light to illuminate one or more portions of a screen of a display device. (e.g., a reflective display layer, etc.). For example, the micro LED light panel layer 208 may generate light to illuminate, at least in part, the reflective display layer 210. In addition, the micro LED light panel layer 208 may increase (or decrease) the amount of light emitted from one or more micro LEDs to increase (or decrease) the brightness of a portion (or section) of a screen (and/or the reflective display layer 210). In some examples, one or more micro LEDs (e.g., any or all of the plurality of micro LEDs 106 or the like) of the micro LED light panel layer 208 may be oriented downward toward underlying layers, such as to illuminate the reflective display layer 210. In some examples, one or more micro LEDs (e.g., any or all of the plurality of micro LEDs 106 or the like) of the micro LED light panel layer 208 may be oriented upward toward the cover lens layer 202. In some examples, one or more micro LEDs (e.g., any or all of the plurality of micro LEDs 106 or the like) of the micro LED light panel layer 208 may be arranged in a grid pattern or any other patterns described herein.

In some examples, the micro LED light panel layer 208 may be configured to generate one or more highlights to emphasize, at least in part, a screen of a display device (e.g., display device 102), such as described above in connection with the highlight 114 shown in FIG. 1B. In some examples, the micro LED light panel layer 208 may be configured to generate one or more images on a screen of a display device (e.g., display device 102), such as described above in connection with the image 112 shown in FIG. 1B. In some examples, a processor of an electronic device (e.g., electronic device 100, etc.) may receive a signal from the touch layer 206 (e.g., from a user input) that defines (or indicates) a position on (or an area of) a screen and, in response, the processor may cause the micro LED light panel layer 208 to generate a highlight (e.g., highlight 114 or the like) at least at the defined position on the screen and/or generate an image (e.g., image 112 or the like) on an area of the screen. In some examples, a processor of an electronic device (e.g., electronic device 100, etc.) may receive a signal from the touch layer 206 (e.g., from a user input) that defines (or indicates) one or more of a brightness, a color, and/or the like and, in response, the processor may cause the micro LED light panel layer 208 to adjust (or change) one or more of the brightness, the color, and/or any other display (or lighting) parameters as described herein.

As shown, the micro LED light panel layer 208 may be configured, positioned, or disposed between the touch layer 206 and the reflective display layer 210. In the depicted example, the micro LED light panel layer 208 may be mechanically coupled below the touch layer 206 by the OCA layer 204B. In addition, in the depicted example, the micro LED light panel layer 208 may be mechanically coupled above the reflective display layer 210 by the OCA layer 204C.

The reflective display layer 210, as shown, may be any reflective display as described herein for generating text, symbols, and/or images. The reflective display layer 210 may comprise one or more of a Color Filter Array (CFA), an Electrophoretic Display (EPD), a Thin-Film Transistor (TFT), a reflective Liquid-Crystal Display (LCD), an Electrochromic Display (ECD), a substrate (e.g., glass, mineral, plastic, polymer, PET, etc.), an encapsulating material (e.g., potting material, plastic, polymer, silicone epoxy resin, polyurethane, etc.), an anti-glare coating, a wire (or electrical conduit), a PCB, and/or any other display materials described herein. In some examples, the reflective display layer 210 may comprise, at least in part, any other reflective display layer(s) as described herein. In some examples, the reflective display layer 210 comprises an electrophoretic display. In some such examples, the electrophoretic display may be configured to render a grayscale image based on generating an electric field by supplying current to pixel electrodes of one or more electrode layers (e.g., a transparent upper electrode layer, a lower electrode layer, and/or the like as described herein). In some examples, the reflective display layer 210 (or the like as described herein) may comprise charged pigment (e.g., microcapsules, etc.) of a first color (e.g., white, black, etc.) having a first charge (e.g., positive, negative, etc.), and charged pigment (e.g., microcapsules, etc.) of a second color (e.g., white, black, etc.) having a second charge (e.g., positive, negative, etc.), the second color being different than the first color and the second charge being opposite the first charge.

As shown, the reflective display layer 210 may be configured to render text (e.g., text 108), symbols (e.g., symbols 110), and/or the like as described herein. For example, the reflective display layer 210 may comprise one or more of a CFA, an EPD, and/or a TFT configured to render digital media (e.g., electronic books, magazines, newspapers, etc.) to a user, such as on an electronic device (e.g., electronic device 100, e-reader device, etc.). In some examples, the CFA may comprise a plurality of color filters (e.g., Red-Green-Blue (RGB) filters, Cyan-Magenta-Yellow (CMY) filters, RGB-White (RGBW) filters, etc.), a substrate material (e.g., glass, plastic, etc.), microlenses, photo resistant pigments (or dyes), and/or the like as described herein. In addition, the CFA may be configured to filter grayscale light (e.g., from greyscale pixels) to create one or more colors (or colored pixels).

In some examples, the EPD may comprise a plurality of microcapsules and/or charged pigment particles (e.g., black and/or white particles) suspended in a (clear or transparent) liquid polymer between a transparent upper electrode layer and a lower electrode layer. In addition, the plurality of microcapsules (and/or charged pigment particles) may comprise a plurality of electrically charged black particles (e.g., carbon, etc.) and white particles (e.g., titanium, etc.) that are configured to render a grayscale text, symbols, and/or the like by aligning (or grouping) together when in the presence of an electric field. For example, the EPD may generate black and/or white pixels by apply an electric field to the plurality of microcapsules using the transparent upper electrode layer and the lower electrode layer. In some examples, the TFT may comprise one or more of a substrate, a transistor (e.g., in a grid pattern, such as a respective transistor for each pixel), and/or the like as described herein. In addition, the TFT may be configured to control a color and/or a brightness of a pixel by regulating voltage to the EPD, the CFA, and/or the like as described herein. In some examples, one or more processors (or the like) of an electronic device (e.g., electronic device 100, etc.) may control the functions of the reflective display layer 210. For example, a processor (e.g., processor(s) 802, etc.) may execute computer executable instructions to display a digital page (or the like) of a book on a display device (e.g., display device 102, etc.), such as an e-reader device (or the like).

As shown, the reflective display layer 210 may be configured, positioned, or disposed between the micro LED light panel layer 208 and the EMR layer 214. In the depicted example, the reflective display layer 210 may be mechanically coupled below the micro LED light panel layer 208 by the OCA layer 204C. In addition, in the depicted example, the reflective display layer 210 may be mechanically coupled above the EMR layer 214 by the PSA layer 212.

The PSA layer 212, as shown, may be any pressure sensitive adhesive configured to mechanically (and/or chemically) couple two or more adjacent layers (e.g., when pressure is applied to the PSA between the two adjacent layers). In some examples, a Pressure Sensitive Adhesive (PSA) may comprise one or more of an elastomer (e.g., rubber, silicone, etc.), a tackifier (e.g., resin, etc.), and/or any other adhesives described herein. It should be understood that a PSA when placed under pressure may flow into any or all microscopic irregularities (e.g., cracks, scratches, gaps, cavities, etc.) of the two adjacent layers and provide a bond (or adhesion) between the two adjacent layers without drying and/or curing. As shown, in the depicted example, the PSA layer 212 may mechanically (and/or chemically) couple the reflective display layer 210 to the EMR layer 214.

The EMR layer 214, as shown, may be any sensor grid configured for detecting electromagnetic signals from a style device. The EMR layer 214 may comprise one or more of a sensor grid (e.g., a wire grid, or the like, laid out in an alternating vertical and horizontal pattern), an electromagnetic coil, a substrate, a PCB, and/or the like as described herein.

As shown, the EMR layer 214 may be configured to generate an electromagnetic field (e.g., to, at least in part, power a stylus device) and/or detect signals generated by a stylus device (e.g., changes induced in the generated electromagnetic field). For example, as a stylus moves along the surface of a display device (e.g., display device 102) the EMR layer 214 may provide power to a coil in the stylus. In response, the coil in the stylus may cause (or induce) changes in the electromagnetic field which the EMR layer 214 may detect and/or utilize to determine (or calculate) a position and/or a direction of movement of the stylus relative to the surface of the display device.

As shown, the EMR layer 214 may be configured, positioned, or disposed as the bottommost layer of the display stack 200 with one or more of the cover lens layer 202, the plurality of OCA layers, the touch layer 206, the micro LED light panel layer 208, the reflective display layer 210, and/or the PSA layer 212 configured (or disposed) over (or above) the EMR layer 214. In the depicted example, the EMR layer 214 may be mechanically coupled to the reflective display layer 210 by the PSA layer 212.

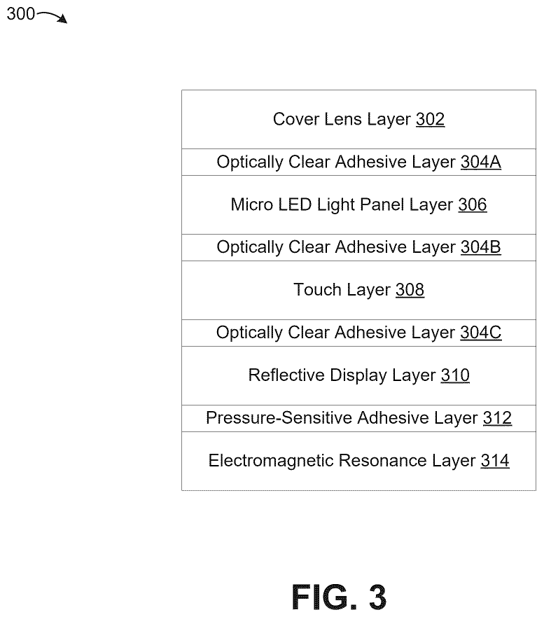

Now that an example display stack for a display device has been described above with reference to at least FIG. 2, another example display stack for a display device will now be described below with reference to FIG. 3.

FIG. 3 illustrates a block diagram of an example display stack for a display device, in accordance with various aspects of the present disclosure. As shown, the display stack 300 may comprise a cover lens layer 302, a plurality of Optically Clear Adhesive (OCA) layers, a micro LED light panel layer 306, a touch layer 308, a reflective display layer 310, a Pressure-Sensitive Adhesive (PSA) layer 312, and/or an Electromagnetic Resonance (EMR) layer 314. In some examples, the display device 102 (described above in connection with FIGS. 1A and 1B) may comprise, at least in part, the display stack 300. In some examples, the display stack 300 may comprise, at least in part, any other display stack(s) as described herein (e.g., display stack 200, etc.). It should be understood that an advantage of the display stack 300 (as depicted in FIG. 3) over traditional display stack configurations (e.g., as shown in FIG. 9) is that the display stack 300 may allow for (or facilitate) a thinner bezel (or frame) configuration (e.g., around the screen) by utilizing micro LEDs throughout the micro LED light panel layer 306 (e.g., in contrast to edge mounted LEDs as shown in FIG. 9).

The cover lens layer 302, as shown, may comprise one or more components and/or aspects of the cover lens layer 202 as described above in connection with FIG. 2 (unless specifically stated otherwise, or otherwise understood within the context of FIG. 3). As shown, the cover lens layer 302 may be configured, positioned, or disposed as the topmost layer of the display stack 300 with one or more of the plurality of OCA layers, the touch layer 308, the micro LED light panel layer 306, the reflective display layer 310, the PSA layer 312, and/or the EMR layer 314 configured (or disposed) underneath (or below) the cover lens layer 302. In the depicted example, the cover lens layer 302 may be mechanically coupled to the micro LED light panel layer 306 by the OCA layer 304A. It should be understood that, in the depicted example of FIG. 3, any area above the cover lens layer 302 may comprise (or define) an exterior environment (relative to a housing of an electronic device) and/or any area below the cover lens layer 302 may comprise (or define) an interior of a housing (e.g., housing 104) of an electronic device (e.g., electronic device 100).

The plurality of OCA layers (e.g., the OCA layer 304A, the OCA layer 304B, and/or the OCA layer 304C), as shown, may comprise one or more components and/or aspects of the plurality of OCA layers (e.g., the OCA layer 204A, the OCA layer 204B, and/or the OCA layer 204C) as described above in connection with FIG. 2 (unless specifically stated otherwise, or otherwise understood within the context of FIG. 3). As shown, a respective OCA layer (e.g., OCA layer 304A, etc.) of the plurality of OCA layers may be configured to mechanically (and/or chemically) couple two or more adjacent layers while maintaining a clear and readable screen (e.g., without bubbling, or warping that may cause image and/or text distortion) of a display device. For example, as shown, the OCA layer 304A may mechanically (and/or chemically) couple the cover lens layer 302 to the micro LED light panel layer 306. In addition, as shown, the OCA layer 304B may mechanically (and/or chemically) couple the micro LED light panel layer 306 to the touch layer 308. Further, as shown, the OCA layer 304C may mechanically (and/or chemically) couple the touch layer 308 to the reflective display layer 310.

The micro LED light panel layer 306, as shown, may comprise one or more components and/or aspects of the micro LED light panel layer 208 as described above in connection with FIG. 2 (unless specifically stated otherwise, or otherwise understood within the context of FIG. 3). As shown, the micro LED light panel layer 306 may be configured, positioned, or disposed between the cover lens layer 302 and the touch layer 206. In the depicted example, the micro LED light panel layer 306 may be mechanically coupled below the cover lens layer 302 by the OCA layer 304A. In addition, in the depicted example, the micro LED light panel layer 306 may be mechanically coupled above the touch layer 308 by the OCA layer 204B.

The touch layer 308, as shown, may comprise one or more components and/or aspects of the touch layer 206 as described above in connection with FIG. 2 (unless specifically stated otherwise, or otherwise understood within the context of FIG. 3). As shown, the touch layer 308 may be configured, positioned, or disposed between the micro LED light panel layer 306 and the reflective display layer 310. In the depicted example, the touch layer 308 may be mechanically coupled below the micro LED light panel layer 306 by the OCA layer 304B. In addition, in the depicted example, the touch layer 308 may be mechanically coupled above the reflective display layer 310 by the OCA layer 204C.

The reflective display layer 310, as shown, may comprise one or more components and/or aspects of the reflective display layer 210 as described above in connection with FIG. 2 (unless specifically stated otherwise, or otherwise understood within the context of FIG. 3). As shown, the reflective display layer 310 may be configured, positioned, or disposed between the touch layer 308 and the EMR layer 314. In the depicted example, the reflective display layer 310 may be mechanically coupled below the touch layer 308 by the OCA layer 304C. In addition, in the depicted example, the reflective display layer 310 may be mechanically coupled above the EMR layer 314 by the PSA layer 312.

The PSA layer 312, as shown, may comprise one or more components and/or aspects of the PSA layer 212 as described above in connection with FIG. 2 (unless specifically stated otherwise, or otherwise understood within the context of FIG. 3). As shown, in the depicted example, the PSA layer 312 may mechanically (and/or chemically) couple the reflective display layer 310 to the EMR layer 314.

The EMR layer 314, as shown, may comprise one or more components and/or aspects of the EMR layer 214 as described above in connection with FIG. 2 (unless specifically stated otherwise, or otherwise understood within the context of FIG. 3). As shown, the EMR layer 314 may be configured, positioned, or disposed as the bottommost layer of the display stack 300 with one or more of the cover lens layer 302, the plurality of OCA layers, the micro LED light panel layer 306, the touch layer 308, the reflective display layer 310, and/or the PSA layer 312 configured (or disposed) over (or above) the EMR layer 314. In the depicted example, the EMR layer 314 may be mechanically coupled to the reflective display layer 310 by the PSA layer 312.

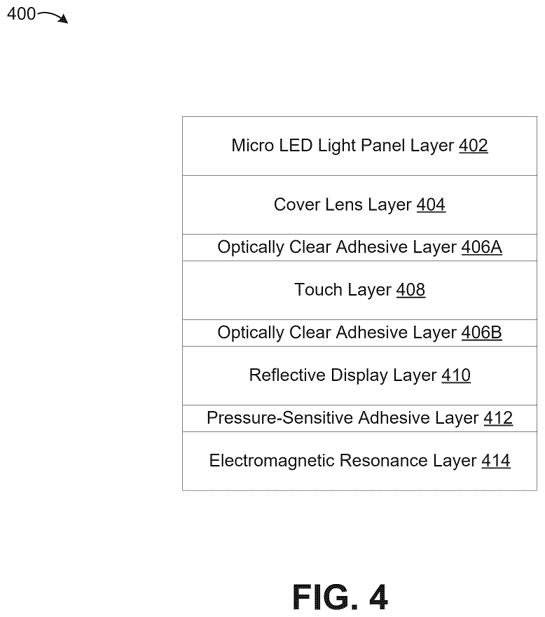

Now that example display stacks for a display device have been described above with reference to at least FIGS. 2 and 3, another example display stack for a display device will now be described below with reference to FIG. 4.

FIG. 4 illustrates a block diagram of an example display stack for a display device, in accordance with various aspects of the present disclosure. As shown, the display stack 400 may comprise a micro LED light panel layer 402, a cover lens layer 404, a plurality of Optically Clear Adhesive (OCA) layers, a touch layer 408, a reflective display layer 410, a Pressure-Sensitive Adhesive (PSA) layer 412, and/or an Electromagnetic Resonance (EMR) layer 414. In some examples, the display device 102 (described above in connection with FIGS. 1A and 1B) may comprise, at least in part, the display stack 400. In some examples, the display stack 400 may comprise, at least in part, any other display stack(s) as described herein (e.g., display stack 200, display stack 300, etc.). It should be understood that an advantage of the display stack 400 (as depicted in FIG. 4) over traditional display stack configurations (e.g., as shown in FIG. 9) is that the display stack 400 may allow for (or facilitate) a thinner display (or screen) configuration by combining, at least in part, the micro LED light panel layer 402 and the cover lens layer 404. Additionally, or alternatively, an advantage of the display stack 400 (as depicted in FIG. 4) over traditional display stack configurations (e.g., as shown in FIG. 9) is that the display stack 400 may allow for (or facilitate) a thinner bezel (or frame) configuration (e.g., around the screen) by utilizing micro LEDs throughout the micro LED light panel layer 402 (e.g., in contrast to edge mounted LEDs as shown in FIG. 9).

The micro LED light panel layer 402, as shown, may comprise one or more components and/or aspects of the micro LED light panel layer 208 as described above in connection with FIG. 2 (unless specifically stated otherwise, or otherwise understood within the context of FIG. 4). As shown, the micro LED light panel layer 402 may be configured, positioned, or disposed as the topmost layer of the display stack 400 with one or more of the cover lens layer 404, the plurality of OCA layers, the touch layer 408, the reflective display layer 410, the PSA layer 412, and/or the EMR layer 414 configured (or disposed) underneath (or below) the micro LED light panel layer 402. In the depicted example, the micro LED light panel layer 402 may be mechanically coupled to the cover lens layer 404. For example, the micro LED light panel layer 402 may be combined with (or fused to) the cover lens layer 404 during manufacturing (e.g., a respective resin substrate (or the like) of each layer may be pressed together prior to each substrate fully curing). In some examples, the micro LED light panel layer 402 and the cover lens layer 404 may share the same (or a common) substrate material (e.g., any substrate as described herein). In some examples, the micro LED light panel layer 402 and the cover lens layer 404 may comprise the same (or a common) hybrid layer comprising, at least in part, the characteristics of both the micro LED light panel layer 402 and the cover lens layer 404 (as described herein). In some examples, the micro LED light panel layer 402 may be combined with (or fused to) the cover lens layer 404 using another intervening adhesive layer (e.g., OCA layer, PSA layer, etc.). It should be understood that, in the depicted example of FIG. 4, any area above the micro LED light panel layer 402 may comprise (or define) an exterior environment (relative to a housing of an electronic device) and/or any area below the micro LED light panel layer 402 may comprise (or define) an interior of a housing (e.g., housing 104) of an electronic device (e.g., electronic device 100).

The cover lens layer 404, as shown, may comprise one or more components and/or aspects of the cover lens layer 202 as described above in connection with FIG. 2 (unless specifically stated otherwise, or otherwise understood within the context of FIG. 4). As shown, the cover lens layer 404 may be configured, positioned, or disposed between the micro LED light panel layer 402 and the touch layer 408. In the depicted example, the cover lens layer 404 may be mechanically (and/or chemically) coupled below the micro LED light panel layer 402 (as described above). In addition, in the depicted example, the cover lens layer 404 may be mechanically coupled above the touch layer 308 by the OCA layer 204A.

The plurality of OCA layers (e.g., the OCA layer 406A and/or the OCA layer 406B), as shown, may comprise one or more components and/or aspects of the plurality of OCA layers (e.g., the OCA layer 204A, the OCA layer 204B, and/or the OCA layer 204C) as described above in connection with FIG. 2 (unless specifically stated otherwise, or otherwise understood within the context of FIG. 4). As shown, a respective OCA layer (e.g., OCA layer 406A, etc.) of the plurality of OCA layers may be configured to mechanically (and/or chemically) couple two or more adjacent layers while maintaining a clear and readable screen (e.g., without bubbling, or warping that may cause image and/or text distortion) of a display device. For example, as shown, the OCA layer 406A may mechanically (and/or chemically) couple the cover lens layer 404 to the touch layer 408. In addition, as shown, the OCA layer 406B may mechanically (and/or chemically) couple the touch layer 408 to the reflective display layer 410.

The touch layer 408, as shown, may comprise one or more components and/or aspects of the touch layer 206 as described above in connection with FIG. 2 (unless specifically stated otherwise, or otherwise understood within the context of FIG. 4). As shown, the touch layer 408 may be configured, positioned, or disposed between the cover lens layer 404 and the reflective display layer 410. In the depicted example, the touch layer 408 may be mechanically coupled below the cover lens layer 404 by the OCA layer 406A. In addition, in the depicted example, the touch layer 408 may be mechanically coupled above the reflective display layer 410 by the OCA layer 406B.

The reflective display layer 410, as shown, may comprise one or more components and/or aspects of the reflective display layer 210 as described above in connection with FIG. 2 (unless specifically stated otherwise, or otherwise understood within the context of FIG. 4). As shown, the reflective display layer 410 may be configured, positioned, or disposed between the touch layer 408 and the EMR layer 414. In the depicted example, the reflective display layer 410 may be mechanically coupled below the touch layer 408 by the OCA layer 406B. In addition, in the depicted example, the reflective display layer 410 may be mechanically coupled above the EMR layer 414 by the PSA layer 412.

The PSA layer 412, as shown, may comprise one or more components and/or aspects of the PSA layer 212 as described above in connection with FIG. 2 (unless specifically stated otherwise, or otherwise understood within the context of FIG. 4). As shown, in the depicted example, the PSA layer 412 may mechanically (and/or chemically) couple the reflective display layer 410 to the EMR layer 414.

The EMR layer 414, as shown, may comprise one or more components and/or aspects of the EMR layer 214 as described above in connection with FIG. 2 (unless specifically stated otherwise, or otherwise understood within the context of FIG. 4). As shown, the EMR layer 414 may be configured, positioned, or disposed as the bottommost layer of the display stack 400 with one or more of the micro LED light panel layer 402, the cover lens layer 404, the plurality of OCA layers, the touch layer 408, the reflective display layer 410, and/or the PSA layer 412 configured (or disposed) over (or above) the EMR layer 414. In the depicted example, the EMR layer 414 may be mechanically coupled to the reflective display layer 410 by the PSA layer 412.

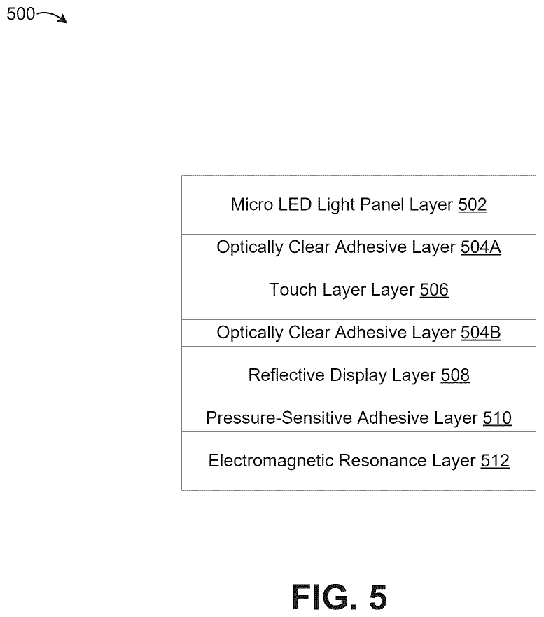

Now that example display stacks for a display device have been described above with reference to at least FIGS. 2-4, another example display stack for a display device will now be described below with reference to FIG. 5.

FIG. 5 illustrates a block diagram of an example display stack for a display device, in accordance with various aspects of the present disclosure. As shown, the display stack 500 may comprise a micro LED light panel layer 502, a plurality of Optically Clear Adhesive (OCA) layers, a touch layer 506, a reflective display layer 508, a Pressure-Sensitive Adhesive (PSA) layer 510, and/or an Electromagnetic Resonance (EMR) layer 512. In some examples, the display device 102 (described above in connection with FIGS. 1A and 1B) may comprise, at least in part, the display stack 500. In some examples, the display stack 500 may comprise, at least in part, any other display stack(s) as described herein (e.g., display stack 200, display stack 300, display stack 400, etc.). It should be understood that an advantage of the display stack 500 (as depicted in FIG. 5) over traditional display stack configurations (e.g., as shown in FIG. 9) is that the display stack 500 may allow for (or facilitate) a thinner display (or screen) configuration by utilizing the micro LED light panel layer 502, at least in part, as a cover lens layer. Additionally, or alternatively, an advantage of the display stack 500 (as depicted in FIG. 5) over traditional display stack configurations (e.g., as shown in FIG. 9) is that the display stack 500 may allow for (or facilitate) a thinner bezel (or frame) configuration (e.g., around the screen) by utilizing micro LEDs throughout the micro LED light panel layer 502 (e.g., in contrast to edge mounted LEDs as shown in FIG. 9).

The micro LED light panel layer 502, as shown, may comprise one or more components and/or aspects of the micro LED light panel layer 208 (and/or the cover lens layer 202) as described above in connection with FIG. 2 (unless specifically stated otherwise, or otherwise understood within the context of FIG. 5). As shown, the micro LED light panel layer 502 may be configured, positioned, or disposed as the topmost layer of the display stack 500 with one or more of the plurality of OCA layers, the touch layer 506, the reflective display layer 508, the PSA layer 510, and/or the EMR layer 512 configured (or disposed) underneath (or below) the micro LED light panel layer 502. In the depicted example, the micro LED light panel layer 502 may be mechanically coupled to the touch layer 506 by the OCA layer 504A. It should be understood that, in the depicted example of FIG. 5, any area above the micro LED light panel layer 502 may comprise (or define) an exterior environment (relative to a housing of an electronic device) and/or any area below the micro LED light panel layer 502 may comprise (or define) an interior of a housing (e.g., housing 104) of an electronic device (e.g., electronic device 100).

The plurality of OCA layers (e.g., the OCA layer 504A and/or the OCA layer 504B), as shown, may comprise one or more components and/or aspects of the plurality of OCA layers (e.g., the OCA layer 204A, the OCA layer 204B, and/or the OCA layer 204C) as described above in connection with FIG. 2 (unless specifically stated otherwise, or otherwise understood within the context of FIG. 5). As shown, a respective OCA layer (e.g., OCA layer 504A, etc.) of the plurality of OCA layers may be configured to mechanically (and/or chemically) couple two or more adjacent layers while maintaining a clear and readable screen (e.g., without bubbling, or warping that may cause image and/or text distortion) of a display device. For example, as shown, the OCA layer 504A may mechanically (and/or chemically) couple the micro LED light panel layer 502 to the touch layer 506. In addition, as shown, the OCA layer 504B may mechanically (and/or chemically) couple the touch layer 506 to the reflective display layer 508.

The touch layer 506, as shown, may comprise one or more components and/or aspects of the touch layer 206 as described above in connection with FIG. 2 (unless specifically stated otherwise, or otherwise understood within the context of FIG. 5). As shown, the touch layer 506 may be configured, positioned, or disposed between the micro LED light panel layer 502 and the reflective display layer 508. In the depicted example, the touch layer 506 may be mechanically coupled below the micro LED light panel layer 502 by the OCA layer 504A. In addition, in the depicted example, the touch layer 506 may be mechanically coupled above the reflective display layer 508 by the OCA layer 504B.

The reflective display layer 508, as shown, may comprise one or more components and/or aspects of the reflective display layer 210 as described above in connection with FIG. 2 (unless specifically stated otherwise, or otherwise understood within the context of FIG. 5). As shown, the reflective display layer 508 may be configured, positioned, or disposed between the touch layer 506 and the EMR layer 512. In the depicted example, the reflective display layer 508 may be mechanically coupled below the touch layer 506 by the OCA layer 504B. In addition, in the depicted example, the reflective display layer 508 may be mechanically coupled above the EMR layer 512 by the PSA layer 510.

The PSA layer 510, as shown, may comprise one or more components and/or aspects of the PSA layer 212 as described above in connection with FIG. 2 (unless specifically stated otherwise, or otherwise understood within the context of FIG. 5). As shown, in the depicted example, the PSA layer 510 may mechanically (and/or chemically) couple the reflective display layer 508 to the EMR layer 512.

The EMR layer 512, as shown, may comprise one or more components and/or aspects of the EMR layer 214 as described above in connection with FIG. 2 (unless specifically stated otherwise, or otherwise understood within the context of FIG. 5). As shown, the EMR layer 512 may be configured, positioned, or disposed as the bottommost layer of the display stack 500 with one or more of the micro LED light panel layer 502, the plurality of OCA layers, the touch layer 506, the reflective display layer 508, and/or the PSA layer 510 configured (or disposed) over (or above) the EMR layer 512. In the depicted example, the EMR layer 512 may be mechanically coupled to the reflective display layer 508 by the PSA layer 510.

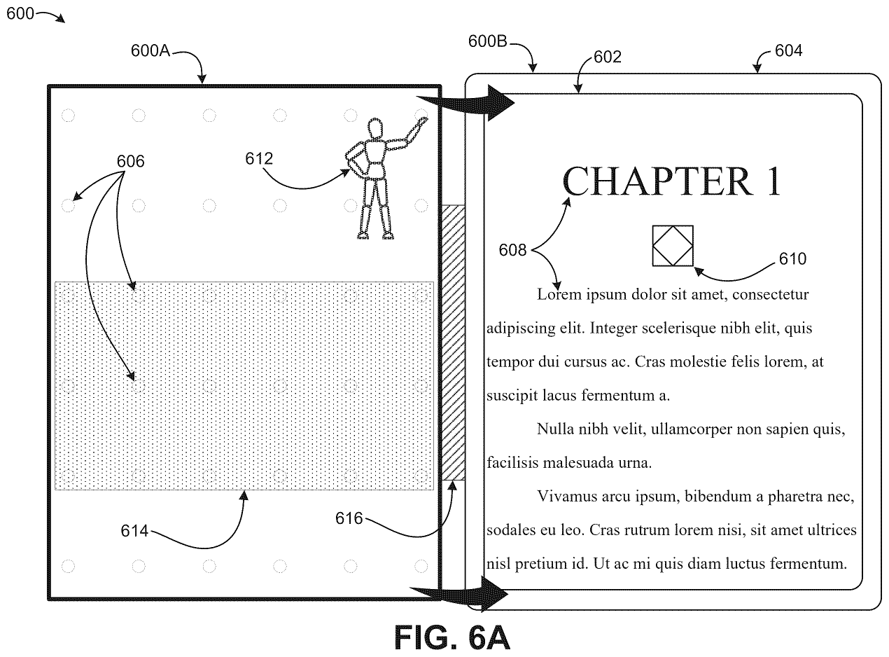

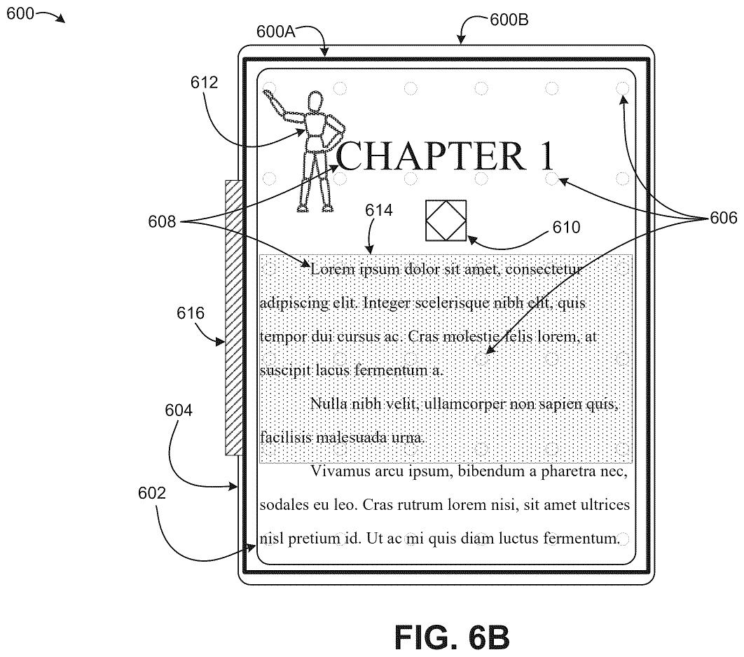

Now that various example electronic devices and example display stacks have been described above with reference to at least FIGS. 1A, 1B, and 2-5, an example lighting system will now be described below with reference to FIGS. 6A and 6B.

FIG. 6A illustrates an example lighting system, in accordance with various aspects of the present disclosure. As shown, the lighting system 600 may comprise a lighting device (or illuminator) 600A and an electronic device 600B.

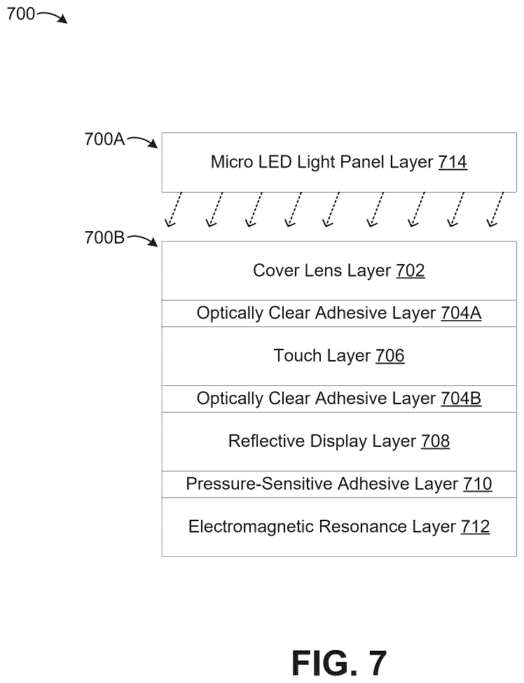

As shown, the lighting device 600A may comprise a plurality of micro LEDs 606 and/or a hinge 616. The lighting device 600A may comprise one or more of a micro LED light panel layer (e.g., as described below in connection with FIG. 7), and/or any other display stack layers configured to render, at least in part, images (e.g., image 612), highlights (e.g., highlight 614), and/or the like. The plurality of micro LEDs 606, as shown, may comprise one or more components and/or aspects of the plurality of micro LEDs 106 as described above in connection with FIGS. 1A and 1B (unless specifically stated otherwise, or otherwise understood within the context of FIGS. 6A and 6B). The image 612 and the highlight 614, as shown, may comprise one or more aspects (or characteristics) of the image 112 and the highlight 114 respectively, as described above in connection with FIGS. 1A and 1B (unless specifically stated otherwise, or otherwise understood within the context of FIGS. 6A and 6B). The hinge 616, as shown, may be any hinge mechanism as described herein. The hinge 616 may comprise one or more of a leaf plate, a knuckle, a pin (or pivot pin), a bushing, a bearing, a living hinge (e.g., plastic, polymer, fabric, etc.), fasteners (e.g., screws, magnets, rivets, spring clips, etc.), and/or any other hinge materials as described herein. As shown, the hinge 616 may be configured to facilitate rotation of the lighting device 600A relative to (e.g., around) the electronic device 600B. For example, the hinge 616, as depicted, may be mechanically coupled to the lighting device 600A (e.g., via a bezel around the plurality of micro LEDs 606 and/or directly to a micro LED light panel layer, such as by using an adhesive and/or fasteners). In addition, the hinge 616, as depicted, may be mechanically coupled to the electronic device 600B (e.g., via a back panel coupled to the housing 604 using magnets or the like).

The plurality of micro LEDs 606, as shown, may be embedded, at least in part, in one or more micro LED light panel layers (e.g., as described below in connection with FIG. 7). In some examples, the plurality of micro LEDs 606 may comprise one or more of a Red Green Blue (RGB) micro LED, a color conversion micro LED, a flexible micro LED, a transparent micro LED, and/or any other micro LED as described herein. As shown, the plurality of micro LEDs 606 are illustrated in a grid pattern and are depicted as being equidistant relative to a lateral axis and/or a longitudinal axis relative to the edges of the lighting device 600A.

It should be understood that the plurality of micro LEDs 606 are shown in the depicted configuration for illustrative purposes and to facilitate clearer description of the examples described herein. Accordingly, the plurality of micro LEDs 606 should not be interpreted as representing only the depicted configuration (e.g., layout, number, size, shape, etc.) unless specifically stated otherwise for a given example and/or otherwise understood within the context of a given example. In some examples, the plurality of micro LEDs 606 may be configured, at least in part, in a staggered pattern, an offset pattern, a curved (or circular) pattern, and/or any other pattern described herein. In some examples, the spacing (or distance) between each pair of micro LEDs along a lateral and/or longitudinal axis may be greater than or less than the spacing (or distances) illustrated in FIGS. 6A and 6B. In some examples, two or more micro LEDs of the plurality of micro LEDs 606 may, at least in part, be configured to touch (or abut). For example, an edge of a first micro LED may be placed against an edge of at least a second micro LED. In some such examples, each micro LED of the plurality of micro LEDs 606 may touch each neighboring micro LED in a lateral direction, a longitudinal direction, and/or a diagonal direction. For instance, the plurality of micro LEDs 606 may be configured to function (or act) as pixels (e.g., render images, etc.). Accordingly, for example, if a display device has a resolution equivalent to 1448×1072 pixels (or any other resolution) then the plurality of micro LEDs 606 may comprise 1448×1072 microscopic LEDs (or any other resolution).

As shown, the electronic device 600B may comprise a display device 602, a housing 604, and/or the like. The electronic device 600B may comprise one or more of an e-reader, a tablet, a smartphone, a laptop computer, and/or any other electronic device (e.g., electronic device 800 as described below in connection with FIG. 8) configured to render, at least in part, text (e.g., text 608), symbols (e.g., symbols 610), and/or the like, such as shown in FIGS. 6A and/or 6B. The display device 602, as shown, may be any display device and/or display circuitry comprising a display stack (e.g., as described below in connection with FIG. 7) for rendering text (e.g., text 608) and/or symbols (e.g., symbols 610). The housing 604, as shown, may comprise one or more components and/or aspects of the housing 104 as described above in connection with FIGS. 1A and 1B (unless specifically stated otherwise, or otherwise understood within the context of FIGS. 6A and 6B). The text 608 and the symbols 610, as shown, may comprise one or more aspects (or characteristics) of the text 108 and the symbols 110 respectively, as described above in connection with FIGS. 1A and 1B (unless specifically stated otherwise, or otherwise understood within the context of FIGS. 6A and 6B).

FIG. 6B illustrates an example lighting system, in accordance with various aspects of the present disclosure. As shown in FIG. 6B, the lighting device (or illuminator) 600A is rotated, at least in part, around the hinge 616 in order to fold the lighting device 600A over the display device 602 of the electronic device 600B. It should be understood that by positioning the lighting device 600A over the display device 602 then the lighting device 600A may illuminate any text (e.g., text 608) and/or symbols (e.g., symbols 610) rendered on the display device 602. In addition, as shown in FIG. 6B, the lighting device 600A may render images (e.g., image 612) and/or highlights (e.g., highlight 614) over the display device 602. It should be appreciated that an advantage of the lighting device 600A is that it can provide the benefits and advantages of using a micro LED light panel layer (as described herein) with traditional display stacks that utilize an edge lit front light LG layer (e.g., as shown in FIG. 9) and/or any display stack(s) described herein.

Now that an example lighting system has been described above with reference to at least FIGS. 6A and 6B, a block diagram for an example lighting system will now be described below with reference to FIG. 7.

FIG. 7 illustrates a block diagram of an example lighting system, in accordance with various aspects of the present disclosure. As shown, the lighting system 700 may comprise a light panel 700A (e.g., of the lighting device 600A) and a display stack 700B (e.g., of the electronic device 600B). The lighting system 700, the light panel 700A, and/or the display stack 700B may comprise one or more components and/or aspects of lighting system 600, the lighting device 600A, and/or the electronic device 600B respectively, as described above in connection with FIGS. 6A and 6B (unless specifically stated otherwise, or otherwise understood within the context of FIG. 7).

As shown, the light panel 700A may comprise a micro LED light panel layer 714. The micro LED light panel layer 714, as shown, may comprise one or more components and/or aspects of the micro LED light panel layer 208 (and/or the cover lens layer 202) as described above in connection with FIG. 2 (unless specifically stated otherwise, or otherwise understood within the context of FIG. 7). In the depicted example, the micro LED light panel layer 714 may be configured, positioned, or disposed as a separate (and/or distinct) layer (e.g., of the lighting device 600A) above (or over) the display stack 700B (e.g., of the electronic device 600B). In some examples, the micro LED light panel layer 714 may be, at least temporarily, held in place over the display stack 700B by the hinge 616 (described above) and/or one or more fasteners (e.g., magnets, clips, etc.) configured to couple to the housing 604 (described above). As shown, the micro LED light panel layer 714 may direct light, at least in part, toward the display stack 700B to illuminate one or more layers (e.g., the reflective display layer 708, etc.).

As shown, the display stack 700B may comprise a cover lens layer 702, a plurality of Optically Clear Adhesive (OCA) layers, a touch layer 706, a reflective display layer 708, a Pressure-Sensitive Adhesive (PSA) layer 710, and/or an Electromagnetic Resonance (EMR) layer 712. In some examples, the display device 602 (described above in connection with FIGS. 6A and 6B) may comprise, at least in part, the display stack 700B. In some examples, the display stack 700B may comprise, at least in part, any other display stack(s) as described herein. The cover lens layer 702, as shown, may comprise one or more components and/or aspects of the cover lens layer 202 as described above in connection with FIG. 2 (unless specifically stated otherwise, or otherwise understood within the context of FIG. 7). The plurality of OCA layers (e.g., the OCA layer 704A and/or the OCA layer 704B), as shown, may comprise one or more components and/or aspects of the plurality of OCA layers (e.g., the OCA layer 204A, the OCA layer 204B, and/or the OCA layer 204C) as described above in connection with FIG. 2 (unless specifically stated otherwise, or otherwise understood within the context of FIG. 7). The touch layer 706, as shown, may comprise one or more components and/or aspects of the touch layer 206 as described above in connection with FIG. 2 (unless specifically stated otherwise, or otherwise understood within the context of FIG. 7). The reflective display layer 708, as shown, may comprise one or more components and/or aspects of the reflective display layer 210 as described above in connection with FIG. 2 (unless specifically stated otherwise, or otherwise understood within the context of FIG. 7). The PSA layer 710, as shown, may comprise one or more components and/or aspects of the PSA layer 212 as described above in connection with FIG. 2 (unless specifically stated otherwise, or otherwise understood within the context of FIG. 7). The EMR layer 712, as shown, may comprise one or more components and/or aspects of the EMR layer 214 as described above in connection with FIG. 2 (unless specifically stated otherwise, or otherwise understood within the context of FIG. 7).

Now that various example display stacks for electronic devices have been described above, a block diagram for an example electronic device will now be described below with reference to FIG. 8.

FIG. 8 illustrates a block diagram for an example electronic device, in accordance with various aspects of the present disclosure. The electronic device 800, as shown, comprises the processor(s) 802, memory 804, network interface(s) 806, and graphics circuit 808. The graphics circuit 808 (e.g., graphics chip, SoC, integrated circuit, graphics card, etc.), as shown, may comprise at least one Graphics Processing Unit (GPU), such as GPU(s) 810. In some examples, the graphics circuit 808 may further comprise dedicated memory and/or may leverage the memory 804. In some examples, the GPU(s) 810 (and/or the like) may comprise one or more features and/or aspects (e.g., multiple processors, multiple cores, cores of different types, etc.) described herein for the processor(s) 802. For example, the graphics circuit 808 may have a dedicated processor (e.g., GPU(s) 810) and/or may further leverage the processor(s) 802 (e.g., CPU(s)). The processor(s) 802 may perform various functions associated with controlling an operation of the electronic device 800, and the memory 804 may store instructions executable by the processor(s) 802 to perform any operations described herein.

As used herein, a processor or CPU, such as the processor(s) 802, may include multiple processors and/or a processor having multiple cores. Further, the processor(s) 802 may comprise one or more cores of different types. For example, the processor(s) 802 may include application processor units, graphic processing units, and so forth. In one implementation, the processor(s) 802 may comprise a microcontroller and/or a microprocessor. The processor(s) 802 may include a microprocessor, a digital signal processor or other processing units or components known in the art. Alternatively, or in addition, the functionality described herein can be performed, at least in part, by one or more hardware logic components. For example, and without limitation, illustrative types of hardware logic components that may be used include Field-Programmable Gate Arrays (FPGAs), Application-Specific Integrated Circuits (ASICs), Application-Specific Standard Products (ASSPs), System on a Chip (SoC), Complex Programmable Logic Devices (CPLDs), and/or the like. Additionally, each of the processor(s) 802 may possess its own local memory, which also may store at least one of program components, program data, program code, program instructions, firmware, software, Operating Systems (OS), and/or the like.

Memory, such as the memory 804, may include volatile and nonvolatile memory, removable and non-removable media implemented in any method or technology for storage of information, such as computer-readable instructions, data structures, program components, firmware, software, and/or any other data. The memory 804 may include, but is not limited to, one or more of RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, and/or any other medium which can be used to store the desired information and which can be accessed by a computing device. The memory 804 may be implemented as Computer-Readable Storage Media (CRSM), which may comprise any available physical media accessible by the processor(s) 802 to execute instructions stored on the memory. In some examples, a CRSM may include random access memory (RAM) and flash memory (e.g., NAND flash, NOR flash, etc.). In other implementations, CRSM may include, but is not limited to, Read-Only Memory (ROM), Electrically Erasable Programmable Read-Only Memory (EEPROM), or any other tangible medium which can be used to store the desired information, and which can be accessed by the processor(s). The memory 804 are examples of non-transitory computer-readable media. The memory 804 may store an Operating System (OS) and one or more software applications, instructions, programs, and/or data to implement the methods described herein and the functions attributed to the various systems. For example, the memory 804 may comprise one or more databases, data tables, datasets, and/or the like as described herein. In some examples, the memory 804 may comprise at least one non-transitory computer-readable memories (or the like as described herein).

Network interface(s) 806 permit the electronic device 800 to communicate over one or more networks. For example, the network interface(s) 806 may permit the electronic device 800 to communicate over one or more communications networks (e.g., the Internet, an intranet, a mobile network, and/or the like). In some examples, a communications network may comprise one or more communications channels, tunnels, Virtual Private Networks (VPNs), and/or the like. In some examples, a communications network may be implemented using encryption techniques (e.g., end to end encryption, etc.). Example network interface(s) 806 include, without limitation, a Wi-Fi circuit (e.g., Dual-band 802.11 a/b/g/n/ac/ax 2×2 MIMO dual-antenna, Tri-band 802.11 a/b/g/n/ac/ax 2×2 MIMO dual-antenna, etc.), ZigBee circuit, Bluetooth circuit (e.g., Bluetooth 5.2, Bluetooth Low Energy (BLE), etc.), LTE circuit, and/or any other communications protocol, hardware, software, and/or firmware. The network interface(s) 806 permit communication with remote device(s), such as mobile devices (e.g., phones, remote controls, microphones, etc.), systems (e.g., cloud services, remote servers, etc.), and/or the like. The network(s) may be representative of any type of communication network, including data and/or voice network, and may be implemented using wired infrastructure (e.g., cable, CAT5, fiber optic cable, etc.), a wireless infrastructure (e.g., radio frequency, cellular, microwave, satellite, Bluetooth, etc.), and/or other connection technologies.

In some instances, inbound data may be routed through the network interface(s) 806 before being directed to the processor(s) 802 and/or GPU(s) 810, and outbound data from the processor(s) 802 and/or GPU(s) 810 may be routed through the network interface(s) 806. The network interface(s) 806 may therefore receive inputs, such as data, from the processor(s) 802, the GPU(s) 810, and/or any other component described herein. For example, the network interface(s) 806 may be configured to transmit data to and/or receive data from one or more network devices (e.g., Wi-Fi routers, etc.). The network interface(s) 806 may act as a conduit for data communicated between various components and the processor(s) 802 and/or the like.

The display device(s) 812 may include any input/output devices described herein for rendering text, images, and/or symbols from a plurality of pixels. Examples of display device(s) 812 may include, without limitation, one or more of an electronic display, a screen, a touchscreen, a light emitting diode (LED) (e.g., micro LED, etc.), e-ink technology, and/or, at least in part, any display device (and/or display stack) as described herein.

Although certain components of the electronic device 800 are illustrated, it is to be understood that the electronic device 800 may include additional and/or alternative components. For example, the electronic device 800 may include other input/output devices (e.g., haptic motors, speakers, light sources, etc.), heat dissipating elements (e.g., heatsinks, fans, vents, etc.), computing components (e.g., Printed Circuit Boards (PCBs), and/or the like. In some examples, one or more components illustrated for the electronic device 800 may be removed or omitted. In some examples, one or more components described herein may be added to or incorporated with electronic device 800. For example, the electronic device 800 may comprise an e-reader device coupled with an external and/or peripheral lighting device (or apparatus) (e.g., as described in connection with FIGS. 6A, 6B, and 7) to produce a e-reader lighting system. Examples of the electronic device 800 may include, without limitation, a server, desktop computer, laptop computer, smartphone, and/or the like as described herein.

Various example systems and processes described herein may include, or be implemented using, or in conjunction with, or for, a device or electronic device. A device or electronic device (e.g., electronic device 800 or the like as described herein) may be, for example, any electronic device comprising processor(s), GPU(s), and/or memory. Further, a device or electronic device may be one or more of a smartphone, a wearable device (e.g., smartwatch, etc.), a tablet, an e-reader, a computer monitor (e.g., screen, display, etc.), a laptop computer, and/or the like as described herein.

As set forth above, certain methods, blocks, and/or operations may be omitted in some implementations. Blocks may be added to, or removed from, some implementations. The systems and apparatuses (or devices) described herein are also not limited to any particular sequence or order, and the blocks relating thereto can be applied in other sequences or orders that are appropriate. For example, described blocks may be assembled in an order other than that specifically disclosed, or multiple blocks may be combined into a single block, state, or layer. For instance, two or more blocks may be integrated (or incorporated) into a single layer. For example, the order of a display stack comprising two or more blocks or layers may be scrambled relative to the order described. It is understood that all such variations are within the scope of the present disclosure.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. The various features and/or processes described above may be used independently of one another or may be combined in various ways. All possible combinations and sub-combinations are intended to fall within the scope of this disclosure.

In addition, conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Although this disclosure has been described in terms of certain example embodiments and applications, other embodiments and applications that are apparent to those of ordinary skill in the art, including embodiments and applications that do not provide all of the benefits described herein, are also within the scope of this disclosure. The scope of the inventions is defined only by the claims, which are intended to be construed without reference to any definitions that may be explicitly or implicitly included in any incorporated-by-reference materials.

What is claimed is:

1. An electronic reader device comprising:
a housing;
at least one processor;
at least one non-transitory computer-readable memory; and
a display device comprising a plurality of layers, wherein the plurality of layers comprise:
a micro light emitting diode (LED) light panel layer comprising a plurality of microscopic LEDs arranged in a grid pattern, wherein a microscopic LED of the plurality of microscopic LEDs is configured to generate visible light;
a touch layer comprising at least one of a capacitive touch sensor, a resistive touch sensor, a glass substrate, or a plastic substrate, where the touch layer is configured to detect a touch input;
a reflective display layer comprising:
an electrophoretic display comprising a plurality of microcapsules suspended in a liquid between a transparent upper electrode layer and a lower electrode layer, wherein the plurality of microcapsules comprises a plurality of electrically charged black and white particles, wherein the electrophoretic display is configured to render a grayscale image based on generating an electric field by supplying current to pixel electrodes of one of the electrode layers; and
a thin-film transistor layer configured to ;
an electromagnetic resonance layer comprising a plurality of sensors arranged in a grid pattern, wherein the electromagnetic resonance layer is configured to generate an electromagnetic field for inductive interaction with a stylus device;
at least one optically clear adhesive layer configured to mechanically couple at least the reflective display layer to either the touch layer or the micro LED light panel layer; and
a pressure-sensitive adhesive layer configured to mechanically couple the reflective display layer to the electromagnetic resonance layer.

2. The electronic reader device of claim 1, wherein the plurality of layers comprises:
a cover lens layer comprising at least one of a scratch resistant glass or a scratch resistant plastic, where the cover lens layer is configured to shield an underlying layer of the plurality of layers from at least one of a scratch, impact, moisture, or debris, wherein the cover lens layer is disposed above the underlying layer comprising at least one of the micro LED light panel layer, the touch layer, the reflective display layer, or the electromagnetic resonance layer.

3. The electronic reader device of claim 2, wherein the micro LED light panel layer is (i) disposed between the cover lens layer and an external environment, or (ii) integrated into the cover lens layer.

4. A display stack comprising:
a reflective display layer comprising:
charged pigment of a first color having a first charge, and
charged pigment of a second color having a second charge, the second color being different than the first color and the second charge being opposite the first charge;
a micro light emitting diode (LED) light panel layer comprising a plurality of micro LEDs arranged and positioned to direct visible light toward the reflective display layer;
a touch sensor layer disposed between the micro LED light panel layer and the reflective display layer;
a first optically clear adhesive (OCA) layer disposed between the micro LED light panel layer and the touch sensor layer; and
a second OCA layer disposed between the reflective display layer and the touch sensor layer.

5. The display stack of claim 4, wherein the touch sensor layer comprises a capacitive touch sensor.

6. The display stack of claim 4, wherein the micro LED light panel layer is a topmost layer of the display stack, wherein the topmost layer of the display stack comprises a boundary between the display stack and an external environment.

7. The display stack of claim 4, comprising:
a cover lens layer, wherein the cover lens layer is a topmost layer of the display stack, wherein the topmost layer of the display stack comprises a boundary between the display stack and an external environment.

8. The display stack of claim 4, wherein the micro LED light panel layer comprises a cover lens layer.

9. The display stack of claim 4, wherein the micro LED light panel layer is disposed between a cover lens layer and the touch sensor layer.

10. The display stack of claim 4, comprising:
a cover lens layer comprising at least one of a glass or a plastic, wherein the micro LED light panel layer is a topmost layer of the display stack, wherein the cover lens layer is disposed between the micro LED light panel layer and the touch sensor layer.

11. The display stack of claim 10, wherein a first substrate of the micro LED light panel layer is fused to a second substrate of the cover lens layer.

12. The display stack of claim 4, wherein the plurality of micro LEDs are arranged in a grid pattern distributed throughout the micro LED light panel layer.

13. The display stack of claim 4, comprising:
a cover lens layer; and
a third optically clear adhesive layer configured to mechanically couple the cover lens layer to the micro LED light panel layer.

14. The display stack of claim 4, comprising:
an electromagnetic resonance layer, wherein the electromagnetic resonance layer is a bottommost layer of the display stack; and
a pressure-sensitive adhesive layer configured to mechanically couple the reflective display layer to the electromagnetic resonance layer.

15. The display stack of claim 4, wherein the touch sensor layer comprises a resistive touch sensor.

16. A display stack comprising:
a cover layer;
a reflective display layer comprising:
charged pigment of a first color having a first charge, and
charged pigment of a second color having a second charge, the second color being different than the first color and the second charge being opposite the first charge;
a micro light emitting diode (LED) light panel layer comprising a plurality of micro LEDs arranged and positioned to direct visible light toward the reflective display layer;
a touch sensor layer disposed between the micro LED light panel layer and the cover layer, wherein the micro LED light panel layer is disposed between the touch sensor layer and the reflective display layer;
a first optically clear adhesive (OCA) layer disposed between the cover layer and the touch sensor layer;
a second OCA layer disposed between the micro LED light panel layer and the touch sensor layer; and
a third OCA layer disposed between the micro LED light panel layer and the reflective display layer.

17. The display stack of claim 16, comprising:
an electromagnetic resonance layer, wherein the electromagnetic resonance layer is a bottommost layer of the display stack.

18. The display stack of claim 17, comprising:
a pressure-sensitive adhesive layer configured to mechanically couple the reflective display layer to the electromagnetic resonance layer.

19. The display stack of claim 16, wherein the touch sensor layer comprises a capacitive touch sensor.

20. The display stack of claim 16, wherein the touch sensor layer comprises a resistive touch sensor.
